(19) United States
(12) Patent Application Publication
(10) Pub. No.: US 2012/0199021 A1
(43) Pub. Date: Aug. 9, 2012

(54) EQUIPMENT FOR PRINTING ON CONTAINERS

(75) Inventor: Heinz Till, Hofheim am Taunus (DE)

(73) Assignee: KHS GmbH

(21) Appl. No.: 13/384,695

(22) PCT Filed: Jul. 8, 2010
(86) PCT No.: PCT/EP2010/004162

§ 371 Date: Apr. 26, 2012

(30) Foreign Application Priority Data
Jul. 18, 2009 (DE) 10 2009 033 810.1

(51) Int. Cl. B41F 17/18

(52) U.S. Cl. 101/36

(57) ABSTRACT

The invention relates to equipment for printing on containers (B), such as bottles, having a printed design (D) on at least one printing machine having at least one print head (1), and is characterised in that the at least one print head (1) is automatically adjustable by means of an electrical controller. An adjustment value from the controller moves the print head (1) according to spatial co-ordinates and/or an angular position into a position that is determined or calculated by means of a measuring device having e.g. sensors from the surface contour and the position relative to the print head (1) of the container (B) to be printed upon.

The invention relates to a plant for printing containers such as bottles with a print image (script and/or image patterns) on at least one printing machine with at least one printing head and to a method carried out thus.

It is known that containers such as bottles and packaging are provided with labels so that consumer information can be attached. It is also known that with ink jet printers, marks or other information is applied to the packaging which makes possible an individualisation that is not permitted by label printing. Such printing systems work in monochrome and are restricted to a few printing dots/lines.

It is known, furthermore, that work is in progress on printing methods and systems which make possible printing of widths of up to 174 mm per printing head using printing heads of different manufacturers. These printing heads also work in monochrome, in the case of a plurality of colours, a plurality of printing heads have to be arranged one after the other and suitably offset so that dependent on the number of the colours an always even between in the individual printing dots is achieved. This is possible with an adjustment on a machine having a plurality of printing heads arranged one after the other in a fixed manner. Here, the packaging material is moved past the printing heads with constant speed. The performance of such a machine is therefore dependent on the printing speed of a respective printing head. This is practicable for absorbent packaging materials. In the case of other materials, such as metals, glass or plastic the ink has to be either dried by heat or by UV or electron rays through cross-linking. This process has to be applied after the printing of each printing colour which increases the length of such machines. If one wishes to increase the performance, either a plurality of printing systems have to be connected in parallel or a different arrangement has to be selected.

There is already the suggestion of arranging on a carousel a plurality of holders for packing material to be printed in circular form and to rotate the individual packaging itself on the individual station during the rotation of the carousel and thus guide the surface of the packaging past a plurality of printing heads arranged on each station and orientated relative to one another. Disadvantageous in this case is that with surfaces that require the use of inks to be cured by UV or electron beam, no intermediate drying or cross-linking of the individual printing inks is possible.

There is therefore the additional proposal of applying each colour on individual carousels arranged one after the other in series, wherein the drying/cross-linking can take place during the transfer between the individual carousels. It is provided, with this embodiment, to fasten the container or the packages on a belt clamped in an independent transport unit, thus moving these in a centred manner one after the other through the various carousels arranged one after the other. This holding device would have to be embodied as rotary mounting so that the containers drive one another on the carousels and thus are guided past the individual printing head of the respective colour with the entire surface.

It was proposed, furthermore, to clamp containers in individual holding devices, wherein each holding device rotatably receives the container and has a marking for the 0 degree angle clamped-in such, the containers are individually transported and received with the holding device in printing machines connected in series. Here, the holding device and the mounting are designed so that a centring of the holding device in the machine takes place with such precision that the container is orientated matching to the print image of the corresponding printing head and through the 0 degree marking, also matching with respect to the rotary axis. The requirements in terms of centring and the accuracy of the guide for achieving a high-quality print image however is high and complex since during start-up and braking down different tensile forces act on the belt and temperature fluctuations can additionally occur both of which lead to tolerances being exceeded that cannot be compensated. It must be considered, furthermore, that the container when it concerns a bottle is heavy, as a rule, since the printing normally takes place after the filling. Added to this weight is the mass of the holding device itself. The precision of the centring requirement becomes clear when one knows that with the usual 600 dpi of printing quality the printing dots are 0.042 mm apart from one another and the heavy bottle holding device has to be therefore permanently aligned to 1/100 mm. With processing quantities of for example 36,000 bottles/h in the beverage industry, more than 200,000,000 annually pass through such a machine. Because of this, the wear and huge and substantially influences the printing quality.

The object of the present invention is to propose a plant of the type mentioned at the outset, with the help of which with reliable operation and high printing quality a high printing output can be achieved.

This object is solved with a plant of the type mentioned at the outset for example in that the at least one printing head is automatically adjustable by means of an electric control device and an adjusting value from the control device moves the printing head into a position according to location coordinates and/or angular position, which is determined or calculated from the surface contour and the position of the bottle to be printed relative to the printing head by means of a capturing device comprising for example sensors.

In this manner it is ensured that with little time expenditure a perfect print image can be applied to the container.

In the plant according to the invention, at least one further printing machine of the type identified beforehand can be arranged downstream of the first printing machine for printing with the same and different colour, so that with the same advantage different-colour print images can be created.

The at least two printing machines can operate individually and independently of each other or interlinked by way of control in order to apply the multi-coloured print image to the container.

To further improve the accuracy of the print image, it is proposed furthermore that in the at least one printing machine on the respective container a marking is printed with the help of which a positioning and/or alignment of the printing head at least of a further printing machine takes place.

The marking can be additionally provided on the print image, for example as irregular polygon, particularly isosceles triangle, but a part of the print image can itself serve as marking.

Here, the marking can be captured via a camera or an image processing device comprising for example sensors, which emits a corresponding output signal to the printing head for positioning it correctly.

Advantageously, with the help of the data gained from the marking for example the printing head of a printing machine connected downstream is adjusted for the printing with the same or a further colour on the print image of a preceding printing machine for example by means of stepping or servo motors in terms of height position, container spacing and/or inclination.

In a practical configuration of the plant according to the invention the respective container to be printed for example is introduced into a station of a carousel (i.e. a rotational treatment machine) by means of an inlet star from a for example linear conveying device, centred in a clamping device and put into rotary motion for printing.

Here, with the help of the data gained from the marking, the rotational angle of the container at which printing commences can be determined.

Advantageously, the respective container during a circulation of the carousel is subjected to a revolution in a station while its surface is being printed.

After this, the respective printed container can be transported out of the carousel by means of a discharge star and if applicable the applied ink cured for example in a UV-tunnel before it, if applicable, is introduced into a further printing machine, if applicable of the same design, for further printing for example in the same manner.

Accordingly, the invention can also be carried out on linear machines.

Further objectives, features, advantages and application possibilities of the invention are obtained from the following description of exemplary embodiments by means of the drawings. Here, all features described and/or represented by image form the subject of the invention by themselves or in any combination even regardless of their combining in individual claims and/or their reference.

It shows:

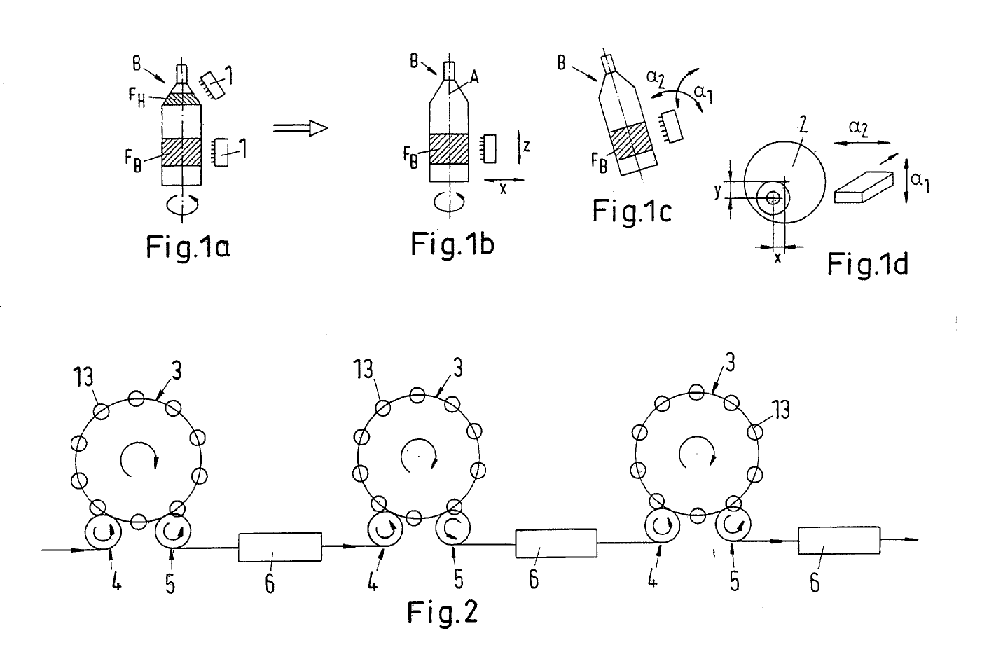

FIGS. 1a to 1d the positioning possibilities of the printing head of the printing machine of a plant according to the invention in principle relative to a container, in the represented case designed as

FIG. 2 a possible arrangement of for example three printing machines in a plant according to the invention one after the other,

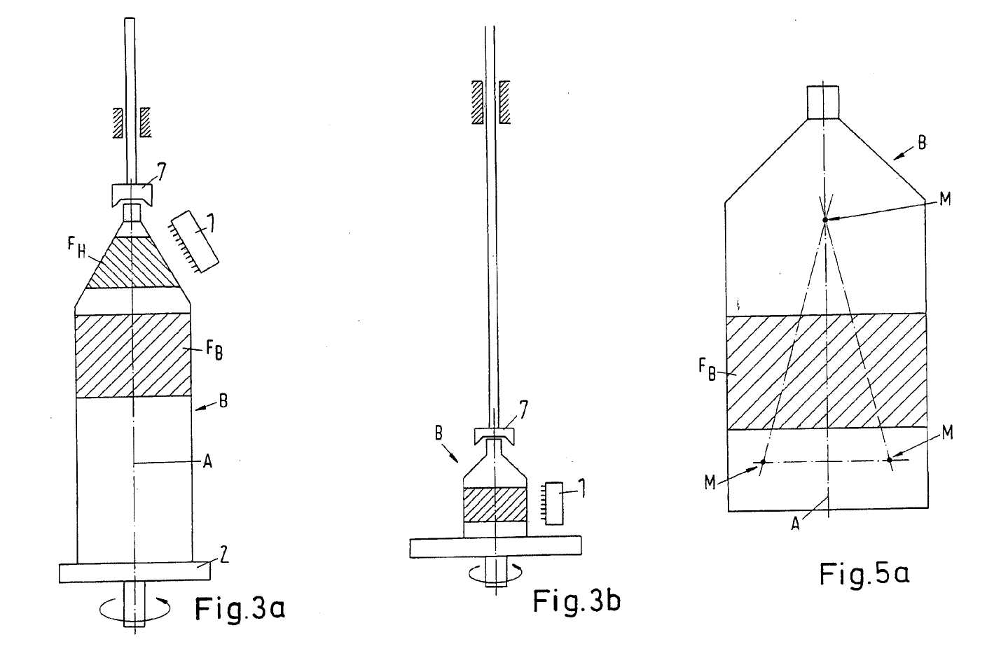

FIGS. 3a and 3b a centring clamping device for two containers of different size in the station for printing in a plant according to the invention,

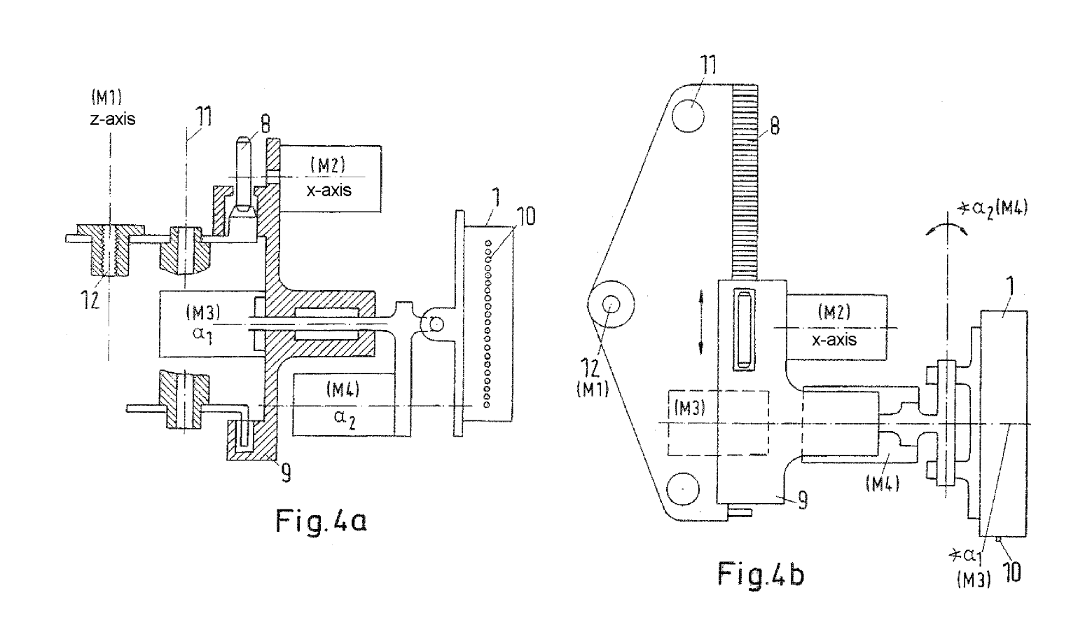

FIGS. 4a and 4b a possible construction of a device for adjusting the printing head in different axes in section and in top view,

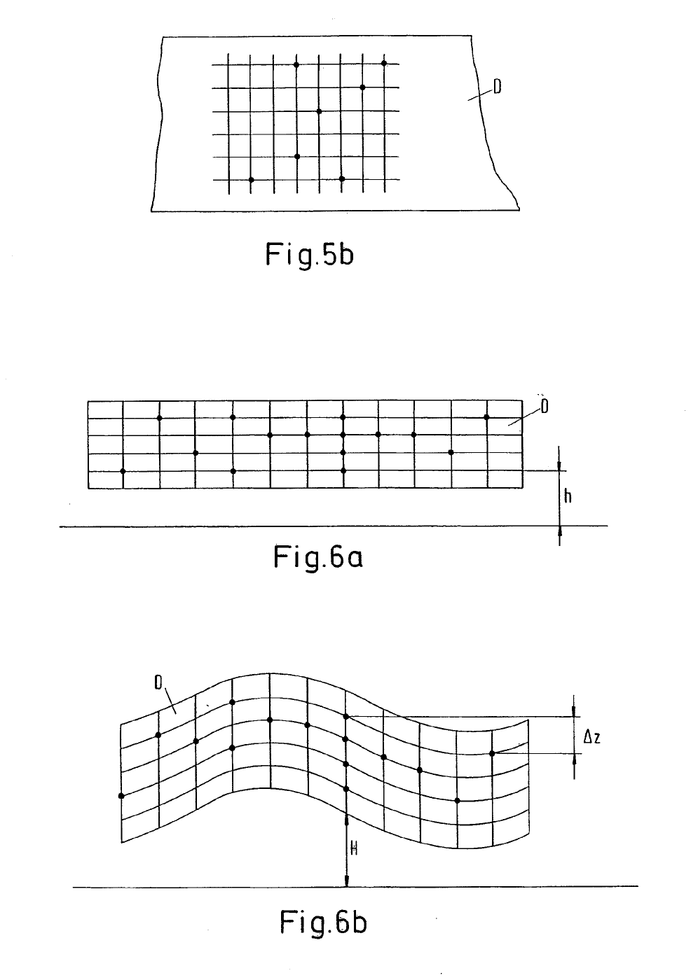

FIGS. 5a and 5b examples of possible markings on the container for determining the position of the printing head, and

FIGS. 6a and 6b a comparison of the development of a print image of a first printing machine on a container in a perpendicular axis position and on a second printing machine with an inclined position randomly resulting there during clamping.

FIG. 1 shows locations at which in principle for example a bottle-shaped container B can be printed by means of a printing head 1, i.e. particularly on the belly (print image surface F_{B}) and on the neck (print image surface F_{H}). The container B during printing is located for example on a turntable 2 (see FIGS. 3a and 3b) where it is put into rotary motion during the printing process. The print image D is applied to the surface of the container B in the region of the print image surface F_{B} or/and F_{H}. The position of the printing head 1 by location coordinates and angular position is automatically determined through the shape and position of the container B, which with the help of a camera or an image processing device senses, which in turn emits corresponding alignment signals to the printing head 1 via a control device. The print image surface F of the container B can be at a height that is different from that of the turntable 2, so that the printing head 1 is adjustable in its height position (z-axis). The distance (x-axis) of the printing head 1 from the container axis A is likewise adjustable, also the angular position of the printing head 1 as a function of the container shape and the alignment of the container. In the case of a bottle, the centre points of bottle bottom and bottle mouth can for example be not in the perpendicular or the same position as in the previous printing machine. Alignment in the angles α₁ and α₂ is provided also for that reason (see FIG. 1d).

FIG. 2 illustrates a plant according to the invention for printing containers B with three rotational treatment machines (carousels) 3 connected one after the other each with a plurality of stations 13. The unprinted containers B are initially brought into the first carousel 3 from a linear conveying section by means of an inlet star 4 and there clamped on one of the stations 13 each on a turntable 2 (see FIGS. 3a and 3b) in a centred manner. During printing, the containers B rotate about their axis A in such a manner that they are subjected to one revolution during a circulation of the carousel 3. The printed containers B are then again transported into the conveying section by means of a discharge star 5 and, after drying or curing of the ink for example in a UV-tunnel 6, reach a second printing machine comprising a carousel 3 for applying the next colour. For example, a container B, from the fourth station 13 of the first printing machine can be placed at the fifth station 13 of the second or the seventh station 13 of the following third printing machine. Since a printing process including container alignment takes approximately 2 seconds, the carousels with 10 containers/sec equals 36,000 containers/h therefore have approximately 8 to 9 stations 13 including inlet/outlet. Aligning the tolerances of 6 printing machines in the case of 6-colour print and 9 stations each, i.e. 72 stations in total such that all containers receive the print image D accurately to 1/100 mm is impossible. For this reason it is important that the distance of the printing head 1 from the turntable middle (in x-direction) is adjustable.

FIGS. 3a and 3b illustrate the clamping of different containers B between a lower turntable 2 and an adjustable counterholder 7. One then distinguishes an adjustment in the x-axis and the z-axis and of the angles α₁ and α₂ when changing over to a different container B or a different position of the print image regarding the height and a fine adjustment during the printing process in order to offset undesirable overshooting of tolerances. The first adjustment substantially occurs during the printing of different containers. The adjusting travels in the process are long if applicable between the position of the print image surface for example with a short bottle and a high bottle or a thin bottle with small diameter and a thick bottle with large diameter. The fine adjustment that takes place during the printing as a rule requires only a few tenths of a millimetres adjustment.

FIGS. 4a and 4b illustrate a possible setup for the adjustment of the printing head 1 in the different axes. FIG. 4a does not show the guide of the set-axis and the spindle drive for the height adjustment. FIG. 4b shows the same arrangement in top view.

FIG. 5a shows an isosceles triangle as marking M for the positioning of the printing head 1 by local coordinates and/or angular position. The triangular points can be located outside or inside the print image surface F. They serve, among other things, for the calculation of the inclined position of the container B and the height of the print image surface F above the turntable 2. When two such triangles have been applied to the container B offset by 90°, the angles α₁ and α₂ (see FIGS. 1d and 4a and 4b) are uniquely definable.

FIG. 5b illustrates an example in which individual dots of the print image D itself are used as marking in order to define or calculate the positioning of the printing head 1 relative to the container B and to output a corresponding adjusting signal to the printing head 1.

Since for example containers to be printed, such as bottles, can be oval and with eccentric position of the container, like a bottle on the respective turntable 2, as a result of which the container does not rotate about the own axis but that of the turntable, it is possible according to the invention to change the distance between printing head 1 and surface to be printed during a revolution of the container, since the print image D according to FIG. 6a on a subsequent printing station presents itself as copy according to FIG. 6b.

According to the invention it is proposed, furthermore, to continuously measure the distance between printing head 1 and container surface by means of sensors in order to readjust the distance value in the x-axis and the angles α₁ and α₂ during the rotation of the container. By doing so, always a same distance to the surface to be printed is present even when for example oval bottles are to be printed.

### LIST OF REFERENCE CHARACTERS

1 Printing head

2 Turntable

3 Carousel

4 Inlet star

5 Outlet star

6 Drying/curing (UV-tunnel)

7 Counterholder

8 Rack

9 Slide (x-axis)

10 Nozzles

11 Guide for z-axis

12 Spindle nut for z-axis

13 Station

A Container axis

B Container

D Print image

F_{B} Print image area belly

F_{H} Print image area neck

M Marking

α₁ Angle of inclination

α₂ Angle of inclination

1-12. (canceled)

13. A plant for printing a print image on containers, said plant comprising a first printing machine having a printing head, a control device, and a capturing device containing sensors, wherein said printing head is automatically adjustable by said control device, and wherein an adjusting value from said control device moves said printing head into a position by location coordinates and/or angular position, said location coordinates and/or angular position being determined or calculated, by said capturing device, from a surface contour and a position of a container to be printed on relative to said printing head.

14. The plant of claim 13, wherein said control device comprises an electrical control device.

15. The plant of claim 13, further comprising a second printing machine, said second printing machine having a printing head that is automatically adjustable by a control device, said second printing machine being arranged downstream of said first printing machine.

16. The plant of claim 15, wherein said second printing machine is configured to print using an ink that differs in color from an ink used by said first printing machine.

17. The plant of claim 15, wherein said first and second printing machines operate individually and independently of each other.

18. The plant of claim 15, wherein said first and second printing machines are interlinked in control.

19. The plant of claim 15, wherein said first printing machine prints a marking on said container, and wherein, with the help of said marking, said printing head of said second printing machine is positioned and/or aligned.

20. The plant of claim 19, wherein said marking includes an irregular polygon printed in addition to said print image.

21. The plant of claim 19, wherein said marking includes an isosceles triangle printed in addition to said print image.

22. The plant of claim 19, wherein said marking is part of said print image.

23. The plant of claim 19, further comprising a camera or an image processing device for capturing said marking and emitting a corresponding alignment signal for said printing head.

24. The plant of claim 13, further comprising sensors for continuously measuring a distance between said printing head and a surface of said container, and wherein a distance to and inclination angles of said surface are readjusted during rotation of said container.

25. The plant of claim 19, wherein, with the help of data gained from said marking, said printing head of said second printing machine is adjusted for printing onto a print image printed by said first printing machine.

26. The plant of claim 25, further comprising at least one of a stepping motor and a servo motor, for adjusting at least one of height position, distance to said container, and inclination of said container relative to said print head.

27. The plant of claim 19, wherein a container to be printed on is introduced into a station of a carousel from a linear conveying device by an inlet star, and wherein, when on said station, said container is centered in a clamping device and rotated.

28. The plant of claim 27, wherein, after at least one revolution of said container for a full circumferential printing, or during a revolution by a few angular degrees for fulfilling printing after alignment of said container in the case of an outer circumferential surface to be only partially printed, a rotational angle of said container at which printing commences or ends is determined with the help of data gained from said marking.

29. The plant of claim 27, wherein during a circulation of said carousel, said container is subjected to at least one revolution in its station while a surface of said container is being printed on.

30. The plant of claim 27, wherein a container that has been printed on is transported out of said carousel by an outlet star.

31. The plant of claim 30, further comprising a UV-tunnel for curing ink applied to said surface of said container before said container is introduced into said second printing machine for further printing.
